(19) United States
(12) Patent Application Publication
(10) Pub. No.: US 2022/0116902 A1
(43) Pub. Date: Apr. 14, 2022

(54) UPLINK POSITIONING FOR IDLE OR INACTIVE TERMINAL DEVICE

(71) Applicant: Nokia Technologies Oy, Espoo (FI)

(72) Inventors: Jianguo LIU, Shanghai (CN); Tao Tao, Shanghai (CN); Yan Meng, Shanghai (CN); Gang Shen, Shanghai (CN)

(21) Appl. No.: 17/424,207

(22) PCT Filed: Feb. 22, 2019
(86) PCT No.: PCT/CN2019/075954

§ 371 Date: Jul. 20, 2021

(51) Int. Cl. H04W 64/00; H04L 5/00; H04W 4/029

(52) U.S. Cl. CPC H04W 64/00; H04W 4/029; H04L 5/0094; H04L 5/0051

(57) ABSTRACT

Example embodiments of the present disclosure relate to methods, devices, apparatuses and computer readable storage media for uplink (UL) positioning of idle or inactive terminal device. In example embodiments, a location management functionality determines a configuration related to an uplink positioning reference signal for a terminal device in an idle or inactive state. The location management functionality indicates the configuration to a location measurement unit. Further, the location management functionality causes a base station to inform the terminal device of the configuration via a paging message to trigger uplink positioning of the terminal device based on the configuration while the terminal device is in the idle or inactive state, or to release the uplink positioning while the terminal device is in the idle or inactive state.

### FIELD

Example embodiments of the present disclosure generally relate to the field of communications, and in particular, to methods, devices, apparatuses and computer readable storage media for uplink (UL) positioning of idle or inactive terminal device.

### BACKGROUND

New Radio (NR) Positioning is proposed for Release 16 (Rel-16) NR. NR-based Radio access Technology (RAT) dependent positioning techniques are being developed to operate in both a frequency range 1 (FR1) from 450 MHz to 6000 MHz (or Sub-6 GHz) and a frequency range 2 (FR2) from 24250 MHz-52600 MHz (or Above-6 GHz or millimeter wave). The RAT dependent positioning techniques comprise a downlink (DL) positioning technology, an uplink (UL) positioning technology and a DL and UL positioning technology. For NR UL positioning, the candidate techniques may be based on timing, angles, carrier phases and a received reference signal power.

Moreover, architecture, functional interfaces, protocol and procedures for location services are being developed to support RAT dependent positioning technologies. For example, in Rel-15 NR, NR Positioning Protocol A (NRPPa) is used for the UL positioning communication between a location service (LCS) server such as an Evolved Serving Mobile Location Center (E-SMLC) and a base station such as a gNB.

The existing UL positioning protocol in NR relies on the LCS server to calculate the locations of user equipment (UEs) using knowledge of their own positions and measurements made at the location measurement units (LMUs). Conventionally, all the signaling exchange between the gNB and the UE shall be conducted when the UE in a Radio Resource Control (RRC) connected state. If the UE in a RRC idle or inactive state, the gNB will firstly page the UE to wake up and return to the RRC connected state, which may causes larger UE power consumption and positioning latency.

### SUMMARY

In general, example embodiments of the present disclosure provide methods, devices, apparatuses and computer readable storage media for UL positioning of idle or inactive terminal device.

In a first aspect, a method is provided. In the method, a location management functionality determines a configuration related to an uplink positioning reference signal for a terminal device in an idle or inactive state. The location management functionality indicates the configuration to a location measurement unit. Further, the location management functionality causes a base station to inform the terminal device of the configuration via a paging message to trigger uplink positioning of the terminal device based on the configuration while the terminal device is in the idle or inactive state, or to release the uplink positioning while the terminal device is in the idle or inactive state.

In a second aspect, a method is provided. In the method, a base station transmits a paging message to a terminal device in an idle or inactive state. The paging message includes a configuration related to an uplink positioning reference signal to trigger uplink positioning of the terminal device based on the configuration while the terminal device is in the idle or inactive state, or to release the uplink positioning while the terminal device is in the idle or inactive state.

In a third aspect, a method is provided. In the method, a terminal device in an idle or inactive state receives a paging message from a base station. The paging message includes a configuration related to an uplink positioning reference signal to trigger uplink positioning based on the configuration or to release the uplink positioning, while the terminal device is in the idle or inactive state. The terminal device transmits the uplink positioning reference signal using the configuration or releasing the uplink positioning in response to the paging message while the terminal device is in the idle or inactive state.

In a fourth aspect, a method is provided. In the method, a location measurement unit obtains a configuration related to an uplink positioning reference signal for a terminal device in an idle or inactive state from a location management functionality. The location measurement unit performs positioning measurement of the terminal device in the idle or inactive state based on the configuration.

In a fifth aspect, a device is provided which comprises at least one processor and at least one memory including computer program code. The at least one memory and the computer program code are configured to, with the at least one processor, cause the device to perform the method according to the first, second, third or fourth aspect.

In a sixth aspect, there is provided an apparatus comprising means for performing the method according to the first, second, third or fourth aspect.

In a seventh aspect, there is provided a computer readable storage medium comprising program instructions stored thereon. The instructions, when executed by a processor of a device, cause the device to perform the method according to the first, second, third or fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates example transition among three Radio Resource Control (RRC) states in NR according to some example embodiments of the present disclosure;

FIG. 2 illustrates an example scenario in which some example embodiments of the present disclosure can be implemented;

FIG. 3 illustrates a high-level signaling flow for UL positioning according to some example embodiments of the present disclosure;

FIG. 4 illustrates a flowchart of an example method according to some example embodiments of the present disclosure;

FIG. 5 illustrates a flowchart of an example method according to some other example embodiments of the present disclosure;

FIG. 6 illustrates a flowchart of an example method according to some example embodiments of the present disclosure;

FIG. 7 illustrates a flowchart of an example method according to some other example embodiments of the present disclosure;

FIG. 8 illustrates an example UL positioning process in accordance with some example embodiments of the present disclosure; and

FIG. 9 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the UE include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “location management functionality” refers to a functionality capable of providing location services or management to the UE. As an example, the location management functionality may be implemented at a device in a core network, such as an Evolved Serving Mobile Location Center (E-SMLC) which may communicate with a base station. As still another example, the location management functionality may be integrated with a base station.

As used herein, the term “location measurement unit” (LMU) or “location measurement functionality” refers to a unit capable of performing positioning measurement on the terminal device. The LMU can communicate with the location management functionality to report the result of the positioning measurement so that the location management functionality can calculate or estimate the location of the terminal device. The LMU may be integrated with a base station or be implemented at a device physically separate from the base station.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

The NR-based RAT dependent positioning techniques are being developed, which comprise DL, UL and DL and UL positioning technologies. For NR UL positioning, the following candidate techniques may be considered:
Timing based techniques
   Timing of arrival path(s)
Angle-based techniques
   Uplink angle(s) of departure
   Uplink angle(s) of arrival
Carrier-phase based techniques
   Feasibility needs to be further assessed.
Received reference signal power based techniques

In addition, proper reference signal to be used for UL positioning is still to be studied, and the following signals may be considered as candidates:
Preamble for NR Physical Random Access Channel (PRACH)
NR Sounding Reference Signal (SRS)
NR UL Demodulation Reference Signal (DMRS)
NR UL Phase Tracking Reference Signal (PTRS)
New UL Positioning Reference Signal (UL PRS)

In NR, a PRACH is conventionally designed for a 4-step random channel access procedure and may be used to request UL grant, re-establish UL synchronization or acquire cell synchronization during handover. The gNB can also use the PRACH for Time of Arrival (TOA) estimation. In some embodiments of the present disclosure, a preamble in the NR PRACH is considered as a positioning reference signal (PRS) for UL positioning, as will be detailed later in the present disclosure.

In addition to the RAT-dependent positioning techniques, the architecture, functional interfaces, protocol and procedures for location services should be developed to support the RAT dependent positioning technologies. The following proposals are presented during positioning related discussion in NR:
Release 15 (Rel-15) NR positioning architecture/protocol is a starting point while the Re-16 Location Services (LCS) architecture enhancement is taken into account in Technical Specification Group Services and System Aspects (TSG SA).
Internet of Things (IoT) use cases, including potential Long Term Evolution (LTE) Positioning Protocol (LPP) evolution, and efficient/low-complexity signaling are considered while striving for a common architecture.
End-to-end latency is considered to develop positioning architecture.

In Rel-15 NR, the NRPPa is used for the UL positioning communication between the LCS server (such as an E-SMLC) and the gNB based on uplink Time Difference of Arrival (UTDOA), for example. The LCS server may initialize a UTDOA information exchange procedure to indicate the gNB to notify user equipment (UE) of transmitting Positioning Reference Signals (PRSs) such as a SRS and retrieving the PRS configuration from the gNB. Using a SLm interface Application Protocol (SLmAP), the LCS server may request Location Measurement Units (LMUs) to perform positioning measurements based on the target UE PRS transmissions. The positioning algorithms may comprise UL Relative Time of Arrival (RTOA), Angle of Arrival (AOA), and the like. Upon completion of the positioning measurements, the LMUs would transfer the measurement results to the LCS server for location calculation or estimation.

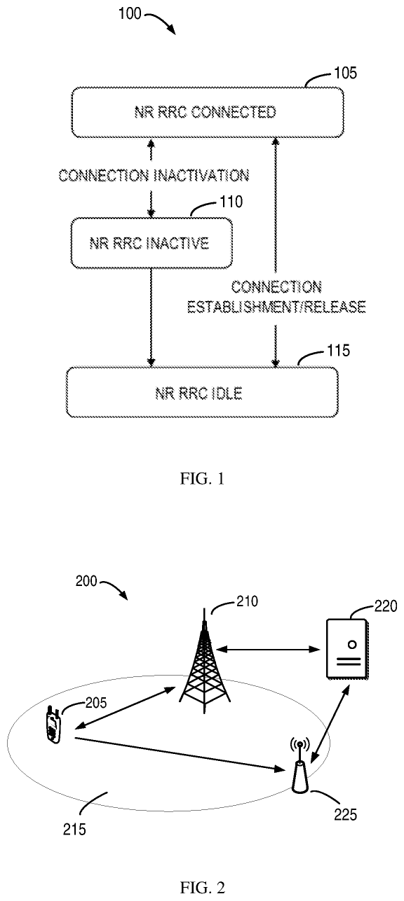

Three Radio Resource Control (RRC) states, including a RRC connected state, a RRC idle state and a RRC inactive state, are supported in NR. FIG. 1 shows example transition among the three states. When the UE is in a RRC connected state 105, the UE can communicate with the gNB using the typical NR physical channels and procedures. In the case that there is no data transmission between the gNB and the UE, the UE may switch to a RRC idle state 110 or a RRC inactive state 115 to reduce the power consumption. As shown, when the UE is in the RRC inactive state 110, the UE can move to the RRC connected state 105 or the RRC idle state 115. However, when the UE in the RRC idle state 115, the UE cannot move to the RRC inactive state 110.

Conventionally, if the UE in the RRC idle or inactive state has data to be transmitted, the UE shall return to the RRC connected state. When the UE is in the RRC inactive state, the UE is allowed to transmit small UL data without a full state transition to the RRC connected state through the 4-step or 2-step RACH procedure.

In NR, the conventional UL positioning protocol requires all the signaling exchange between the gNB and the UE to be conducted when the UE in the RRC connected state. For example, in order to support UL positioning, the gNB triggers or configures a target UE to perform PRACH transmission, for example, when an uplink TOA estimate is needed for the UE. Once the LCS server receives a positioning requirement from a LCS client for an UE in the RRC idle or inactive state, the gNB will firstly page the UE to wake up from the RRC idle or inactive state and return to the RRC connected state. As a result, the large UE power consumption and positioning latency may be caused by setup or resume of the RRC connection with a Mobility Management Entity (MME).

However, it is agreed that physical layer latency, UE power consumption, scalability/capacity, network deployment complexity, availability, UE and gNB complexity can be considered as important design factors for NR positioning solutions and can be evaluated analytically for proposed solutions. In particular, low power consumption is an important feature for IoT UEs.

In this situation, it is desirable to support positioning for RRC idle and inactive UEs. Conventional solutions only focus on DL NR positioning in an idle or inactive state. For example, a measurement report via Early Data Transmission (EDT) may be beneficial for NR UEs to reduce the power consumption and end-to-end latency for DL positioning operation. Till now, a solution to address the UL NR positioning is till unavailable.

Example embodiments of the present disclosure provide novel UL positioning schemes for a terminal device in an idle or inactive state such as a RRC idle or inactive state. These schemes allow the terminal device to transmit a UL positioning reference signal (PRS) based on a configuration related to the UL PRS to enable UL positioning when the terminal device is in the idle or inactive state. The UL positioning for the idle or inactive terminal device is directly configured (for example, triggered or released) based on a paging mechanism. As such, the UE power consumption and positioning delay may be significantly reduced, as well as control signaling overhead for the connection setup or resume.

FIG. 2 shows an example environment 200 in which example embodiments of the present disclosure can be implemented. The environment 200, which may be a part of a communication network, comprises a terminal device 205 and a base station 210. It is to be understood that one base station and one terminal device are shown in the environment 200 only for the purpose of illustration, without suggesting any limitation to the scope of the present disclosure. Any suitable number of base stations and terminal devices may be included in the environment 200.

As shown, the terminal device 205 is located in a cell 215 served by the base station 210. The terminal device 205 can communicate with the base station 210 or with another terminal device (not shown) directly or via the base station 210. The communication may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

As shown, the environment 200 further comprises a location management functionality 220 and a location measurement unit (LMU) 225 for providing location services to the terminal device 205. It is to be understood that one location management functionality and one LMU are shown in the environment 200 only for the purpose of illustration, without suggesting any limitation to the scope of the present disclosure. There may be any suitable number of location management functionalities and LMUs. For example, the location management functionality 220 may communication with a plurality of base stations and LMUs for UL positioning.

It is also to be understood that the physically separate arrangement of the base station 210, the location management functionality 220 and the LMU 225 is shown for the purpose of illustration, without suggesting any limitation. As another example, the location management functionality 220 and/or the LMU 225 may be integrated within the base station 210 or a further base station (not shown).

In various embodiments, through the base station 210 and the location management functionality 220, UL PRS transmission at the terminal device 205 and UL positioning measurement at the LMU 225 are synchronized with a configuration related to the PRS (for example, a positioning dedicated resource configuration) when the terminal device 205 is in an idle or inactive state.

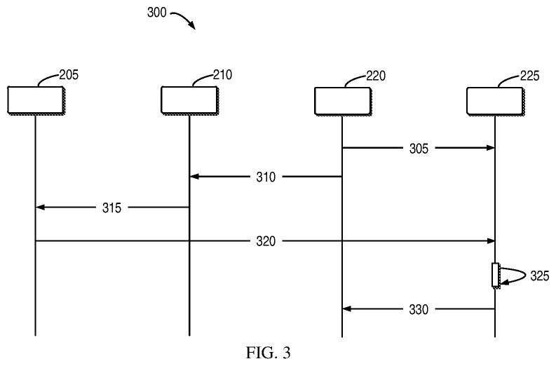

FIG. 3 illustrates a high-level signaling flow 300 between the devices in the environment 200 in accordance with some example embodiments of the present disclosure.

As shown in FIG. 3, the location management functionality 220 triggers (305) a UL positioning procedure at the LMU 215 for the terminal device 205 when the terminal device 205 is in an idle or inactive state such as a RRC idle or inactive state. The triggering may be responsive to a positioning request for the terminal device 205 from a LCS client. The LCS client may be a software and/or hardware entity that may interact with the location management functionality to obtain location information for one or more terminal devices. The LCS client may subscribe to location services in order to obtain location information. The LCS client may or may not interact with human users. The LCS client may be capable of formatting and presenting data and managing a user interface (for example, a dialogue). As an example, the LCS client may reside in a terminal device.

In order to trigger (305) the UL positioning procedure at the LMU 215, the location management functionality 220 determines a configuration related to a UL PRS for the terminal device 205 in an idle or inactive state. Then, the location management functionality 220 indicates the LMU 225 to perform positioning measurement (for example, TOA) with the related configuration.

The configuration may comprise any suitable configuration related to the PRS transmission. For example, the configuration may comprise at least one of a positioning dedicated channel configuration and an indication of the PRS to trigger the UL positioning. The indication of the PRS may comprise at least one of a sequence index and a cyclic shift of the PRS. The configuration may further comprise positioning assistance data. The positioning assistance data may comprise a duration of the PRS transmissions and the number of PRS transmissions, a period of the PRS transmissions and the like.

As an example, a random access preamble to be transmitted in a PRACH may serve as the PRS, which means that the PRS transmission may be completed during a RACH procedure. Other implementations of the PRS may be possible, which may include a sounding reference signal (SRS), a phase tracking reference signal (PTRS) and the like. The positioning dedicated channel configuration may comprise a resource (e.g., at least one of a time resource and a frequency resource) for the PRS.

In some example embodiments, a set of positioning dedicated channel configurations may be predefined in the environment 200 for UL positioning of a terminal device in an idle or active state. The set of positioning dedicated channel configurations may be common to all terminal devices in one or more cells.

The set of positioning dedicated channel configurations may be determined by the location management functionality 220 or the base station 210. In the former case, the location management functionality 220 may send the set of positioning dedicated channel configurations to the terminal device 205 via the base station 210.

In some embodiments, at least a part of the predefined configurations may be sent (e.g., via broadcasting) by the base station 210 to the terminal device 205 in the cell 215. The predefined configurations may be sent to the terminal device 205 through any suitable signaling, which may include but not be limited to system information or RRC signaling.

In some other example embodiments, each base station may have an independent set of configurations (determined by itself or assigned by the location management functionality) and broadcast the set of configurations in a serving cell. For example, the base station 210 may determine a set of PRACH configurations to be used in the UL positioning of a terminal device in an idle or active state. Note that the set of PRACH configurations may be dedicated for UL positioning use, or may also be used for initial access. The base station 210 may broadcast the set of PRACH configurations in the cell 215. Accordingly, the terminal device 205 may receive the set of configurations, e.g., through a RRC singling broadcast in the cell 215. In some example embodiments, when the terminal device 205 triggers a UL positioning procedure in the idle or inactive state, the terminal device 205 may use one of the set of configurations determined and broadcast by the last serving base station in a Radio Access Network (RAN) tracking area of the terminal device 205 when the terminal device 205 is in a connected state before transition to the idle or inactive state.

In addition to triggering the UL positioning procedure at the LMU 215, the location management functionality 220 indicates (310) the base station 210 to page the terminal device 205 to trigger or release the UL positioning of the terminal device 205 in the idle or inactive state. The base station 210 may be in the RAN tracking area of the terminal device 205. The location management functionality 220 may indicate all or a part of base stations in the RAN tracking area of the terminal device 205 to page the terminal device 205.

The base station 210 sends (315) a paging message to the terminal device 205. The paging message may include a positioning flag to indicate the triggering or releasing of the UL positioning procedure at the terminal device 205. In some example embodiments, the paging message indicates the triggering of the uplink positioning and includes the configuration for the PRS.

In response to the paging message indicating triggering of the UL positioning, the terminal device 205 transmits (320) the PRS (e.g., a RACH preamble) based on the configuration while keeping in the idle or inactive state. The LMU 225 performs (325) the positioning measurement during the PRS transmission, and the reports (330) the positioning measurement to the location management functionality 220 for location calculation of the terminal device 205 while the terminal device 205 stays at the idle or inactive state.

In this way, the fast configuration (for example, triggering or releasing) of the UL positioning may be enabled for the idle or inactive terminal device. The PRS transmission at a terminal device and the PRS measurement at LMUs may be allowed without UL synchronization between the terminal device and a base station. Accordingly, the UE power consumption and the positioning latency may be reduced. Moreover, no connection setup or resume is needed, and therefore the control signaling overhead may be reduced in the network.

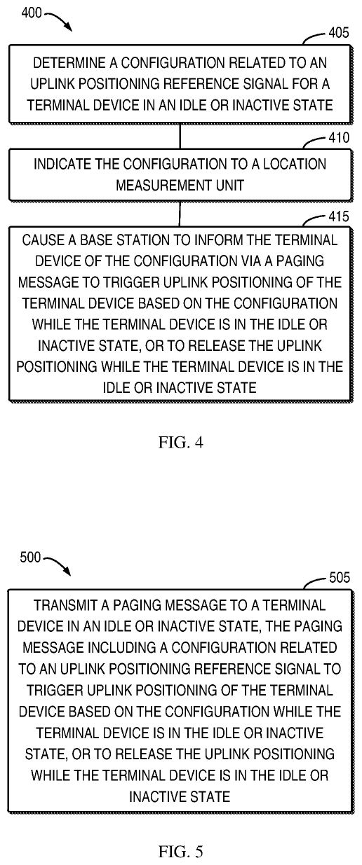

FIG. 4 shows a flowchart of an example method 400 according to some example embodiments of the present disclosure. The method 400 can be implemented by the location management functionality 220 as shown in FIG. 2. For the purpose of discussion, the method 400 will be described with reference to FIG. 2.

At block 405, the location management functionality 220 determines a configuration related to a UL PRS for the terminal device 205 in the idle or inactive state. For example, when the location management functionality 220 receives a positioning request for the terminal device 205 in the idle or inactive state, the location management functionality 220 determines the configuration of the PRS.

As an example, the configuration may comprise a positioning dedicated channel configuration. The positioning dedicated channel configuration comprises a resource for transmitting the UL PRS. The PRS may comprise, but not be limited to, a random access preamble, a sounding reference signal and a phase tracking reference signal.

The positioning dedicated channel configuration may be determined in any suitable way. In some example embodiments, the positioning dedicated channel configuration may be selected by the location management functionality 220 from a set of positioning dedicated channel configurations. The set of positioning dedicated channel configurations may be assigned by the location management functionality 220 to a plurality of terminal devices.

The set of positioning dedicated channel configurations may be sent to terminal devices via a base station. For example, the location management functionality 220 may send at least a subset of the set of positioning dedicated channel configurations to the surrounding base stations. The base stations may broadcast the positioning dedicated channel configurations to terminal devices in the serving cells.

Alternatively, the set of positioning dedicated channel configurations may be predefined in the network. Accordingly, each terminal device may obtain the set of positioning dedicated channel configurations without additional signaling from the location management functionality 220 and use a positioning dedicated channel configuration from the set of positioning dedicated channel configurations.

The set of positioning dedicated channel configurations may contain any suitable number of positioning dedicated channel configurations. In some example embodiments, only one common positioning dedicated channel configuration is predefined. All the terminal devices use this configuration. In this case, no signaling exchange is needed to inform the configuration in the network, and the signaling overhead may be further reduced.

In some example embodiments, a plurality of positioning dedicated channel configurations may be predefined. The location management functionality 220 may determine which positioning dedicated channel configuration will be used by the terminal device 205. The determined configuration needs to be indicated to the terminal device 205. The use of the plurality of common configurations may reduce the conflict among UL positioning of different terminal devices.

In some example embodiments, the positioning dedicated channel configuration may be determined by the base station 210 or a further base station to improve the configuration flexibility. For example, each base station may determine and broadcast an independent positioning dedicated channel configuration for use in UL positioning of a terminal device in the idle or inactive state. In this case, the location management functionality 220 may obtain the positioning dedicated channel configurations broadcast by the base station 210 and other surrounding base stations. The location management functionality 220 may determine a positioning dedicated channel configuration for the terminal device 205 from the received positioning dedicated channel configurations.

In some example embodiments, the positioning dedicated channel configuration assigned to the terminal device 205 may be the positioning dedicated channel configuration determined and broadcast by a base station that serves that terminal device 205 when the terminal device 205 is in a connected state before transition to the idle or inactive state. In this example, both the location management functionality 220 and the terminal device 205 may store the positioning dedicated channel configuration. In some other example embodiments, the location management functionality 220 may determine, for the UL positioning of the terminal device 205, the positioning dedicated channel configuration determined by the base station 210 from which the terminal device 205 receives the paging message. Then the location management functionality 220 indicates the determined configuration to the location measurement unit. As such, the synchronization of UL PRS transmission and measurement may be facilitated with the reduced signaling overhead.

In some example embodiments, the configuration may include an indication of the PRS. The indication of the positioning reference signal may comprise at least one of a sequence index and a cyclic shift of the positioning reference signal. The location management functionality may determine the UL PRS for the terminal device 205 when the terminal device 205 is in the idle or inactive state. The format of the PRS may be predefined or fixed in related technical specification(s). The PRS may also be assigned by the location management functionality 220 to the terminal device 205. For example, the location management functionality 220 may assign the PRS to the terminal device 205 by selecting the PRS from a set of PRSs reserved for UL positioning. The selection of the PRS may be random or based on a predetermined rule. As such, the determination of the PRS may be more flexible.

Furthermore, taking the limitation of the number of available PRSs into consideration, the location management functionality 220 may recycle the assigned PRSs for a further terminal device upon the completion of the UL positioning of the terminal device 205. For example, after the duration of the PRS transmission is expired or the number of PRS transmissions is reached, the PRS assigned to the terminal device 205 may be released for future use.

In some example embodiments, the configuration may comprise positioning assistance data to facilitate the UL positioning. For example, the positioning assistance data may comprise duration of PRS transmissions, the number of PRS transmissions and a period of PRS transmissions. It is to be understood that the configuration may include other information for facilitating the UL positioning.

At block 410, the location management functionality 220 indicates the configuration to the LMU 225. In some example embodiments, the LMU 225 may be located around the serving cell of the terminal device 205. For example, the location management functionality 220 may indicate the configuration to a part or all of the LMUs around the last serving cell of the terminal device 205, so that the LMUs can perform positioning measurement of the terminal device 205 to ensure the accuracy of the UL positioning. Based on the report of location information from the LMUs, the location management functionality 220 may perform location calculation of the terminal device 205 while the terminal device 205 stays in the idle or inactive state.

At block 420, the location management functionality 220 causes the base station 210 to page the terminal device 205 to inform the terminal device 205 of the configuration via a paging message to trigger UL positioning of the terminal device based on the configuration while the terminal device is in the idle or inactive state, or to release the UL positioning while the terminal device is in the idle or inactive state. In some example embodiments, the base station 210 may be located around the last serving cell of the terminal device 205. For example, based on the location of the last serving cell, the location management functionality 220 indicates all or a part of the base stations around the last serving cell to page the terminal device 205 in the RAN tracking area of the terminal device 205. When the terminal device 205 is in the idle or inactive state, the movement of the terminal device 205 is unknown to the network side. The paging from the multiple base stations in the RAN tracking area of the terminal device 205 may increase the probability of paging success and reduce the paging latency for the terminal device 205.

The location management functionality 220 may be located inside or outside of the base station 210. If the location management functionality 220 is implemented within the base station 210 as a functionality or unit, the location management functionality 220 may cause the base station 210 to page the terminal device 205 through an internal instruction or signal in the base station 220. In the example embodiments where the location management functionality 220 and the base station 210 are physically separate, the location management functionality 220 may send, to the base station 210, a paging indication for the base station 210 to page the terminal device 205 to trigger or release the UL positioning while the terminal device 205 is in the idle or inactive state.

In some example embodiments, the paging indication may include the configuration for PRS for the terminal 205. For example, if more than one common positioning dedicated configuration is determined, an indication of a positioning dedicated channel configuration assigned to the terminal device 205 may be carried in the paging indication. Alternatively or in addition, the duration of the PRS transmissions or the number of PRS transmissions or a periodicity of the PRS transmissions may be carried in the paging indication so that the base station 210 may indicate the terminal device 205 to automatically perform or release the UL positioning based on the configuration.

The configuration may indicate the triggering or releasing of the UL positioning. For example, the configuration may indicate the triggering with a triggering flag. The configuration may indicate the releasing if a resource assignment for the UL PRS is absent from the configuration, the resource assignment is set to a predefined value indicating the releasing, or a release flag is included in the configuration. In order words, the UL positioning may be triggered or released explicitly or implicitly through the configuration.

All operations and features as described above with reference to FIGS. 2 and 3 are likewise applicable to the method 400 and have similar effects. For the purpose of simplification, the details will be omitted.

FIG. 5 shows a flowchart of an example method 500 according to some example embodiments of the present disclosure. The method 500 can be implemented by the base station 210 as shown in FIG. 2. For the purpose of discussion, the method 500 will be described with reference to FIG. 2.

At block 505, the base station 210 transmits a paging message to the terminal device 205 in the idle or inactive state. The paging message includes a configuration related to an uplink positioning reference signal to trigger UL positioning of the terminal device 205 based on the configuration while the terminal device 205 is in the idle or inactive state, or to release the UL positioning while the terminal device 205 is in the idle or inactive state.

In some example embodiments, the base station 210 transmits the paging message to the terminal device 205 in response to a reception of a paging indication from the location management functionality 220 that may be separate from the base station 210. The paging indication orders the base station 210 to page the terminal device 205 to trigger or release the UL positioning while the terminal device 205 is in the idle or inactive state.

In some example embodiments, the paging indication may include the configuration for triggering the UL positioning or releasing the UL positioning.

In some example embodiments, the configuration included in the paging message may optionally comprise at least one of a positioning dedicated channel configuration and an indication of the PRS to trigger the uplink positioning. In some example embodiments, the indication of the positioning reference signal may comprise at least one of a sequence index and a cyclic shift of the PRS.

In some example embodiments, the positioning dedicated channel configuration is selected from a set of positioning dedicated channel configurations. For example, the positioning dedicated channel configuration is selected by the location management functionality 220 that is physically separate from the base station 210. If the location management functionality 220 is integrated with the base station 210, the positioning dedicated channel configuration is selected by the base station 210 through the internal location management functionality 220.

The base station 210 may obtain at least a subset of the set of positioning dedicated channel configuration from the location management functionality 220. For example, if the location management functionality 220 is located inside the base station 210, the base station 210 may obtain the subset through internal instructions or signals. If the location management functionality 220 is located outside of the base station 210, the base station 210 may receive the subset from the location management functionality 220 via an air interface or a device-to-device interface. In some example embodiments, the base station 210 may send at least a subset of the set of positioning dedicated channel configurations to the terminal device 205. For example, the base station 210 may broadcast at least a subset of the set of positioning dedicated channel configurations in the cell 215.

In some example embodiments, the base station 210 may determine and broadcast a positioning dedicated channel configuration for UL positioning of a terminal device in an idle or inactive state. In some example embodiments, the positioning dedicated channel configuration determined by the base station 210 may be the positioning dedicated channel configuration to be used in the UL positioning of the terminal device 205 in the idle or inactive state.

In some example embodiments, the positioning dedicated channel configuration comprises a resource for transmitting the UL PRS. In some embodiments, a RACH request or RACH preamble sent by the terminal device 205 during a RACH procedure if the paging message may serve as the PRS. In some embodiments, the UL PRS may comprise one of an uplink positioning preamble, a sounding reference signal and a phase tracking reference signal.

It should be appreciated that, in some embodiments, only one common positioning dedicated channel configuration is predefined for UL positioning, and in such cases, no signaling is needed to inform UE of the configuration, and therefore the configuration included in the paging message may not indicate the positioning dedicated channel configuration.

In some example embodiments, the configuration included in the paging message may further comprise at least one of duration of transmissions of the uplink positioning reference signal, the number of transmissions of the uplink positioning reference signal and a period of transmissions of the uplink positioning reference signal.

All operations and features as described above with reference to FIGS. 2-4 are likewise applicable to the method 500 and have similar effects. For the purpose of simplification, the details will be omitted.

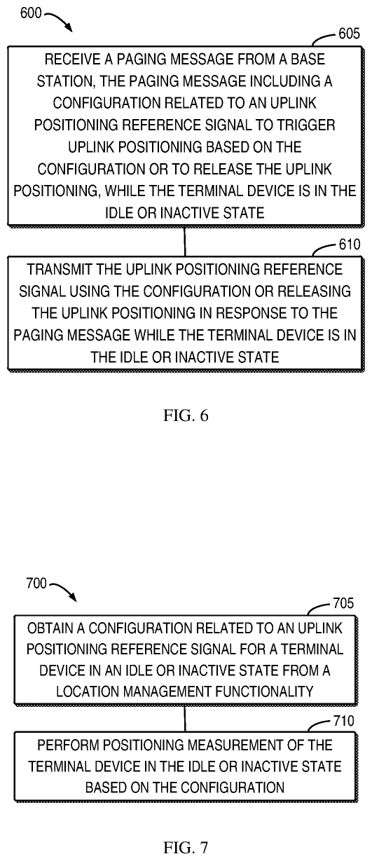

FIG. 6 shows a flowchart of an example method 600 according to some example embodiments of the present disclosure. The method 600 can be implemented by the terminal device 205 as shown in FIG. 2. For the purpose of discussion, the method 600 will be described with reference to FIG. 2.

At block 605, the terminal device 205 receives the paging message from the base station 210. The paging message comprises a configuration related to a UL PRS to trigger UL positioning based on the configuration or to release the uplink positioning, while the terminal device 205 is in the idle or inactive state. For example, in a paging window, the idle or inactive terminal device 205 may monitor the paging message. The paging window may be predefined for the terminal device 205, for example, by a higher layer signaling.

Once the terminal device 205 detects the paging message, the terminal device 205 may transmit the PRS or release the UL positioning, while keeping in the idle or inactive state. Accordingly, at block 610, the terminal device 205 transmits the UL PRS using the configuration or releasing the UL positioning in response to the paging message while the terminal device 205 is in the idle or inactive state. For example, the configuration may comprise a positioning dedicated channel configuration that comprises a resource (e.g., at least one of a time resource and a frequency resource) for the PRS transmission. The terminal device 205 may transmits the PRS at the corresponding time and/or in the corresponding frequency band.

In the example embodiments where the positioning dedicated configuration comprises at least one of duration of PRS transmissions and the number of PRS transmissions, the terminal device 205 may cease the transmission of the PRS if the duration of transmission is expired and/or the number of transmissions is reached. The terminal device 205 may also cease the transmission of the PRS if the paging message indicates the releasing of the uplink positioning, so that the release of the UL positioning may be triggered at a network side. Then, the terminal device 205 may enter a sleeping mode for power saving while keeping in the idle or inactive state if no further transmission is desired.

The terminal device 205 may determine the positioning dedicated channel configuration to be used in any suitable way. In some example embodiments, the positioning dedicated channel configuration may be included in the configuration carried in the paging message. In some example embodiments, the terminal device 205 may receive the positioning dedicated channel configuration broadcast by the base station 210. In some other example embodiments, the positioning dedicated channel configuration may be predefined in the network, and the terminal device 205 may be aware of the positioning dedicated channel without additional signaling exchange with the network side.

In the example embodiments where a set of positioning dedicated channel configurations may be defined for UL positioning, the terminal device 205 may receive the set of positioning dedicated channel configurations broadcast by the surrounding base stations. The set of positioning dedicated channel configurations may be predefined in the network, assigned by the location management functionality 220 or determined independently by the individual base stations.

In some example embodiments, the positioning dedicated channel configuration to be used for the UL positioning may be determined independently by a base station that serves the terminal device 205 when the terminal device 205 is in a connected state before transition to the idle or inactive state. In this example, the terminal device 205 may receive the positioning dedicated configuration broadcast by the serving base station and store the positioning dedicated configuration for future use.

FIG. 7 shows a flowchart of an example method 700 according to some example embodiments of the present disclosure. The method 700 can be implemented by the LMU 225 as shown in FIG. 2. For the purpose of discussion, the method 700 will be described with reference to FIG. 2.

At block 705, the LMU 225 obtains a configuration related to an uplink positioning reference signal (e.g., PRACH preamble) for the terminal device 205 in the idle or inactive state from the location management functionality 220.

In some example embodiments, the PRS and associated configuration may be predefined in the network. In some example embodiments, the LMU 225 may receive the configuration from the location management functionality 220 which is physically separate from the LMU 225. If the LMU 225 and the location management functionality 220 are integrated within one device such as a base station, the LMU 225 may obtain the configuration through internal instructions or signals within the device.

At block 710, the LMU 225 performs positioning measurement of the terminal device 205 in the idle or inactive state based on the configuration. For example, the LMU 225 may detect the PRS based on the configuration and performs positioning measurement of the terminal device 205 based on the detecting. The positioning measurement may be implemented based on any suitable positioning algorithm, such as UL Relative Time of Arrival (RTOA), Time of Arrival (TOA), Observed Time Difference Of Arrival (OTDOA), Uplink Time Difference of Arrival (UTDOA) and Angle of Arrival (AOA).

If the time resource for the PRS transmission is fixed or predefined or obtained by the LMU 225 at block 705, the LMU 225 can perform positioning measurement during the window of the PRS transmission. If the time resource is not fixed in the configuration, the LMU 225 may blindly measure the UL PRS based on the frequency resource which is fixed or predefined in in the configuration for example.

In some example embodiments, the configuration obtained by the LMU 225 at block 705 comprises a positioning dedicated channel configuration for the terminal device 205. Then the LMU 225 performs positioning measurement of the terminal device 205 in the idle or inactive state based on the configuration.

Alternatively, in some embodiments, the positioning dedicated channel configuration used by the terminal device for UL positioning is determined from a set of positioning dedicated channel configurations and the location management functionality 220 specifies no specific positioning dedicated channel configuration for the terminal device 205 at block 705, the LMU 205 may blindly detect the PRS by using the individual positioning dedicated channel configurations one by one. For example, if the positioning dedicated channel configuration is one of the positioning dedicated channel configuration independently determined by the individual base stations in the RAN tracking area of the terminal device 205, the LMU 225 may try the individual positioning dedicated channel configuration to detect the PRS from the terminal device 205.

The LMU 225 may report the positioning measurement to the location management functionality 220 so that the location management functionality 220 can perform the location calculation of the terminal device 205 based on the report of location information from the LMU 225 and possibly other LMUs around the terminal device 205 while the terminal device 205 stays in an idle or inactive state.

All operations and features as described above with reference to FIGS. 2-5 are likewise applicable to the methods 600 and 700 and have similar effects. For the purpose of simplification, the details will be omitted.

In some example embodiments, the methods 400 to 700 described above with reference to FIGS. 2-7 may be performed by an apparatus comprising means for performing the respective operations of the methods 400 to 700. The means may be implemented in any suitable form. For example, the means may be implemented in a circuitry or software module.

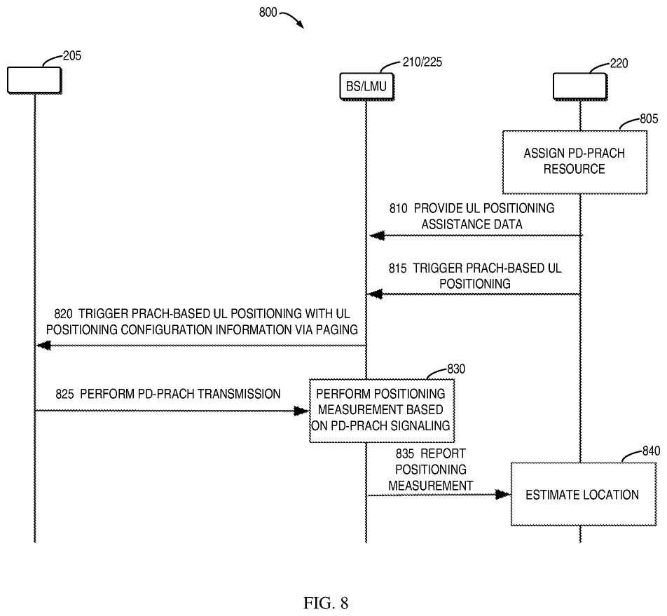

FIG. 8 shows a UL positioning process 800 in accordance with some example embodiments of the present disclosure. The process 800 can be implemented in the environment 200. For the purpose of discussion, the process 800 may be described with reference to FIG. 8.

In this example, the UL PRS is a preamble transmitted in a PRACH, and the configuration related to the UL PRS is a resource configuration for the PRACH. In such a case, the terminal device 205 does not need to transmit further reference signals for positioning related measurement in addition to the RACH procedure.

As shown, the location management functionality 220 assigns (805) a Positioning Dedicated PRACH (PD-PRACH) resource for the terminal device 205. The location management functionality 220 provides (810) the UL positioning assistance data to the LMU 225. In this example, as shown, the LMU 225 is integrated with the base station 210.

The location management functionality 220 triggers (815) PRACH-based UL positioning for the idle or inactive terminal device 205 in the RAN tracking area. In some other cases, the location management functionality 220 may trigger a release of the PRACH-based UL positioning in this operation.

The base station 210 triggers (820) the PRACH-based UL positioning with the configuration information via paging. The terminal device performs (825) PD-PRACH transmission. The LMU 225 performs (830) the positioning measurement based on PD-PRACH signaling. The LMU 225 reports (835) the positioning measurement to the location management functionality 220. The location management functionality 220 estimates (840) the location of the terminal device 205.

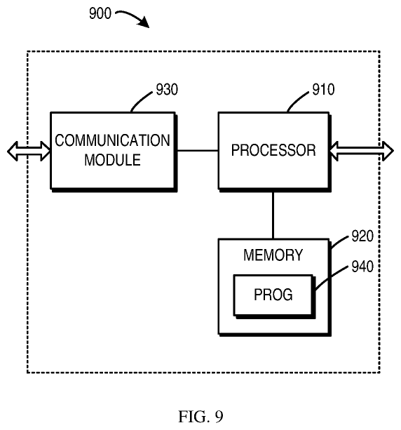

FIG. 9 is a simplified block diagram of a device 900 that is suitable for implementing example embodiments of the present disclosure. The device 900 can be implemented at or as a part of the location management functionality 220, the base station 210, the terminal device 205 or the LMU 225 as shown in FIG. 2.

As shown, the device 900 includes a processor 910, a memory 920 coupled to the processor 910, a communication module 930 coupled to the processor 910, and a communication interface (not shown) coupled to the communication module 930. The memory 920 stores at least a program 940. The communication module 930 is for bidirectional communications, for example, via multiple antennas. The communication interface may represent any interface that is necessary for communication.

The program 940 is assumed to include program instructions that, when executed by the associated processor 910, enable the device 900 to operate in accordance with the example embodiments of the present disclosure, as discussed herein with reference to FIGS. 2 to 8. The example embodiments herein may be implemented by computer software executable by the processor 910 of the device 900, or by hardware, or by a combination of software and hardware. The processor 910 may be configured to implement various example embodiments of the present disclosure, e.g., any of methods 400-700.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

When the device 900 acts as the location management functionality 220 or a part of the location management functionality 220, the processor 910 and the communication module 930 may cooperate to implement the method 400 as described above with reference to FIG. 4. When the device 900 acts as the base station 210 or a part of the base station 210, the processor 910 and the communication module 930 may cooperate to implement the method 500 as described above with reference to FIG. 5. When the device 900 acts as the terminal device 205 or a part of the terminal device 205, the processor 910 and the communication module 930 may cooperate to implement the method 600 as described above with reference to FIG. 6. When the device 900 acts as the LMU 225 or a part of the LMU 225, the processor 910 and the communication module 930 may cooperate to implement the method 700 as described above with reference to FIG. 7.

All operations and features as described above with reference to FIGS. 2 to 8 are likewise applicable to the device 900 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 to 700 as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: determining, by a location management functionality, a configuration related to an uplink positioning reference signal for a terminal device in an idle or inactive state; indicating the configuration to a location measurement unit; and causing a base station to inform the terminal device of the configuration via a paging message to trigger uplink positioning of the terminal device based on the configuration while the terminal device is in the idle or inactive state, or to release the uplink positioning while the terminal device is in the idle or inactive state.

In some example embodiments, the causing comprises: sending a paging indication to the base station, the paging indication including the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the method further comprises: sending a set of positioning dedicated channel configurations including the positioning dedicated channel configuration to the terminal device via the base station.

In some example embodiments, the method further comprises: obtaining the positioning dedicated channel configuration from the bases station or a further base station, the further base station serving the terminal device before the terminal device transits to the idle or inactive state.

In some example embodiments, the positioning dedicated channel configuration comprises a resource for transmitting the uplink positioning reference signal, and wherein the uplink positioning reference signal comprises one of the following for the uplink positioning: a random access preamble, a sounding reference signal, and a phase tracking reference signal.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some example embodiments, the location management functionality is located inside or outside of the base station, and the location measurement unit is located inside or outside of the base station.

In some aspects, a method comprises: transmitting, by a base station, a paging message to a terminal device in an idle or inactive state, the paging message including a configuration related to an uplink positioning reference signal to trigger uplink positioning of the terminal device based on the configuration while the terminal device is in the idle or inactive state, or to release the uplink positioning while the terminal device is in the idle or inactive state.

In some example embodiments, the method further comprises: receiving, from a location management functionality separate from the base station, a paging indication for paging the terminal device to trigger or release the uplink positioning while the terminal device is in the idle or inactive state; and the transmitting comprises transmitting the paging message to the terminal device in response to the reception of the paging indication.

In some example embodiments, the paging indication includes the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration is selected from a set of positioning dedicated channel configurations, and the method further comprises: sending at least a subset of the set of positioning dedicated channel configurations to the terminal device.

In some example embodiments, the method further comprises: receiving at least the subset of the set of positioning dedicated channel configurations from the location management functionality.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the location management functionality is located inside or outside of the base station.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some aspects, a method comprises: receiving, by a terminal device in an idle or inactive state, a paging message from a base station, the paging message including a configuration related to an uplink positioning reference signal to trigger uplink positioning based on the configuration or to release the uplink positioning, while the terminal device is in the idle or inactive state; and transmitting the uplink positioning reference signal using the configuration or releasing the uplink positioning in response to the paging message while the terminal device is in the idle or inactive state.

In some example embodiments, the configuration comprises the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the method further comprises: obtaining a set of positioning dedicated channel configuration including the positioning dedicated channel configuration from the base station or a further base station, the further base station serving the terminal device before the terminal device transits to the idle or inactive state.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some aspects, a method implemented by a location measurement unit comprises: obtaining a configuration related to an uplink positioning reference signal for a terminal device in an idle or inactive state from a location management functionality; and performing positioning measurement of the terminal device in the idle or inactive state based on the configuration.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the location management functionality and the location measurement unit are located in one device or difference devices.

In some aspects, a device comprises: at least one processor; and at least one memory including computer program code; the at least one memory and the computer program code configured to, with the at least one processor, cause the device to: determine a configuration related to an uplink positioning reference signal for a terminal device in an idle or inactive state; indicate the configuration to a location measurement unit; and cause a base station to inform the terminal device of the configuration via a paging message to trigger uplink positioning of the terminal device based on the configuration while the terminal device is in the idle or inactive state, or to release the uplink positioning while the terminal device is in the idle or inactive state.

In some example embodiments, the device is caused to send a paging indication to the base station, the paging indication including the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the device is further caused to: send a set of positioning dedicated channel configurations including the positioning dedicated channel configuration to the terminal device via the base station.

In some example embodiments, the device is further caused to: obtain the positioning dedicated channel configuration from the bases station or a further base station, the further base station serving the terminal device before the terminal device transits to the idle or inactive state.

In some example embodiments, the positioning dedicated channel configuration comprises a resource for transmitting the uplink positioning reference signal, and wherein the uplink positioning reference signal comprises one of the following for the uplink positioning: a random access preamble, a sounding reference signal, and a phase tracking reference signal.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some example embodiments, the location management functionality is located inside or outside of the base station, and the location measurement unit is located inside or outside of the base station.

In some aspects, a device comprises: at least one processor; and at least one memory including computer program code; the at least one memory and the computer program code configured to, with the at least one processor, cause the device to: transmit a paging message to a terminal device in an idle or inactive state, the paging message including a configuration related to an uplink positioning reference signal to trigger uplink positioning of the terminal device based on the configuration while the terminal device is in the idle or inactive state, or to release the uplink positioning while the terminal device is in the idle or inactive state.

In some example embodiments, the device is further caused to: receive, from a location management functionality separate from the base station, a paging indication for paging the terminal device to trigger or release the uplink positioning while the terminal device is in the idle or inactive state; and the device is caused to transmit the paging message to the terminal device in response to the reception of the paging indication.

In some example embodiments, the paging indication includes the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration is selected from a set of positioning dedicated channel configurations, and the device is further caused to: send at least a subset of the set of positioning dedicated channel configurations to the terminal device.

In some example embodiments, the device is further caused: receive at least the subset of the set of positioning dedicated channel configurations from the location management functionality.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the location management functionality is located inside or outside of the base station.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some example embodiments, a device comprises: at least one processor; and at least one memory including computer program code; the at least one memory and the computer program code configured to, with the at least one processor, cause the device to: receive a paging message from a base station, the paging message including a configuration related to an uplink positioning reference signal to trigger uplink positioning based on the configuration or to release the uplink positioning, while the device is in the idle or inactive state; and transmit the uplink positioning reference signal using the configuration or releasing the uplink positioning in response to the paging message while the device is in the idle or inactive state.

In some example embodiments, the configuration comprises the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the device is further caused to: obtain a set of positioning dedicated channel configuration including the positioning dedicated channel configuration from the base station or a further base station, the further base station serving the device before the device transits to the idle or inactive state.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some example embodiments, a device comprises: at least one processor; and at least one memory including computer program code; the at least one memory and the computer program code configured to, with the at least one processor, cause the device to: obtain a configuration related to an uplink positioning reference signal for a terminal device in an idle or inactive state from a location management functionality; and perform positioning measurement of the terminal device in the idle or inactive state based on the configuration.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the location management functionality and the location measurement unit are located in one device or difference devices.

In some aspects, an apparatus comprises: means for determining a configuration related to an uplink positioning reference signal for a terminal device in an idle or inactive state; means for indicating the configuration to a location measurement unit; and means for causing a base station to inform the terminal device of the configuration via a paging message to trigger uplink positioning of the terminal device based on the configuration while the terminal device is in the idle or inactive state, or to release the uplink positioning while the terminal device is in the idle or inactive state.

In some example embodiments, the means for causing comprises: means for sending a paging indication to the base station, the paging indication including the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the apparatus further comprises: means for sending a set of positioning dedicated channel configurations including the positioning dedicated channel configuration to the terminal device via the base station.

In some example embodiments, the apparatus further comprises: means for obtaining the positioning dedicated channel configuration from the bases station or a further base station, the further base station serving the terminal device before the terminal device transits to the idle or inactive state.

In some example embodiments, the positioning dedicated channel configuration comprises a resource for transmitting the uplink positioning reference signal, and wherein the uplink positioning reference signal comprises one of the following for the uplink positioning: a random access preamble, a sounding reference signal, and a phase tracking reference signal.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some example embodiments, the location management functionality is located inside or outside of the base station, and the location measurement unit is located inside or outside of the base station.

In some aspects, an apparatus comprises: means for transmitting a paging message to a terminal device in an idle or inactive state, the paging message including a configuration related to an uplink positioning reference signal to trigger uplink positioning of the terminal device based on the configuration while the terminal device is in the idle or inactive state, or to release the uplink positioning while the terminal device is in the idle or inactive state.

In some example embodiments, the apparatus further comprises: means for receiving, from a location management functionality separate from the base station, a paging indication for paging the terminal device to trigger or release the uplink positioning while the terminal device is in the idle or inactive state; and the means for transmitting comprises means for transmitting the paging message to the terminal device in response to the reception of the paging indication.

In some example embodiments, the paging indication includes the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration is selected from a set of positioning dedicated channel configurations, and the method further comprises: sending at least a subset of the set of positioning dedicated channel configurations to the terminal device.

In some example embodiments, the apparatus further comprises: means for receiving at least the subset of the set of positioning dedicated channel configurations from the location management functionality.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the location management functionality is located inside or outside of the base station.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some aspects, an apparatus comprises: means for receiving a paging message from a base station, the paging message including a configuration related to an uplink positioning reference signal to trigger uplink positioning of a terminal device in an idle or inactive state based on the configuration or to release the uplink positioning, while the terminal device is in the idle or inactive state; and means for transmitting the uplink positioning reference signal using the configuration or releasing the uplink positioning in response to the paging message while the terminal device is in the idle or inactive state.

In some example embodiments, the configuration comprises the configuration for one of the following: triggering the uplink positioning; and releasing the uplink positioning.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the apparatus further comprises: means for obtaining a set of positioning dedicated channel configuration including the positioning dedicated channel configuration from the base station or a further base station, the further base station serving the terminal device before the terminal device transits to the idle or inactive state.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the configuration indicates the releasing of the uplink positioning if one of the following is satisfied: a resource assignment for the uplink positioning reference signal is absent from the configuration; the resource assignment is set to a predefined value (e.g., “NULL”, or “RESERVED”) for indicating the releasing; and a release flag is included in the configuration.

In some aspects, an apparatus comprises: means for obtaining a configuration related to an uplink positioning reference signal for a terminal device in an idle or inactive state from a location management functionality; and means for performing positioning measurement of the terminal device in the idle or inactive state based on the configuration.

In some example embodiments, the configuration comprises at least one of a positioning dedicated channel configuration and an indication of the positioning reference signal to trigger the uplink positioning.

In some example embodiments, the indication of the positioning reference signal comprises at least one of a sequence index and a cyclic shift of the positioning reference signal.

In some example embodiments, the configuration further comprises at least one of: a duration of transmissions of the uplink positioning reference signal, the number of transmissions of the uplink positioning reference signal, and a period of transmissions of the uplink positioning reference signal.

In some example embodiments, the positioning dedicated channel configuration comprises a resource for transmitting the uplink positioning reference signal, and wherein the uplink positioning reference signal comprises one of the following for uplink positioning: a random access preamble, a sounding reference signal, and a phase tracking reference signal.

In some example embodiments, the location management functionality and the location measurement unit are located in one device or difference devices.

1.-21. (canceled)

22. A method comprising:
receiving, by a terminal device in an idle or inactive state, a paging message from a base station, the paging message including a configuration related to an uplink positioning reference signal for triggering uplink positioning based on the configuration or releasing the uplink positioning, while the terminal device is in the idle or inactive state; and
transmitting the uplink positioning reference signal based on the configuration or releasing the uplink positioning in response to the paging message while the terminal device is in the idle or inactive state.

23. (canceled)

24. The method of claim 22, wherein the configuration comprises at least one of a positioning dedicated channel configuration or an indication of the positioning reference signal to trigger the uplink positioning.

25. The method of claim 24, wherein the indication of the positioning reference signal comprises at least one of a sequence index or a cyclic shift of the positioning reference signal.

26. The method of claim 25, further comprising:
obtaining a set of positioning dedicated channel configuration including the positioning dedicated channel configuration from the base station or a further base station serving the terminal device before the terminal device transits to the idle or inactive state.

27. The method of claim 24, wherein the configuration further comprises at least one of:
a duration of transmissions of the uplink positioning reference signal,
the number of transmissions of the uplink positioning reference signal, or
a period of transmissions of the uplink positioning reference signal.

28. The method of claim 24, wherein the positioning dedicated channel configuration comprises a resource for transmitting the uplink positioning reference signal, and wherein the uplink positioning reference signal comprises one of the following for uplink positioning:
a random access preamble,
a sounding reference signal, or
a phase tracking reference signal.

29. The method of claim 22, wherein the configuration indicates the releasing of the uplink positioning if one of the following is satisfied:
a resource assignment for the uplink positioning reference signal is absent from the configuration;
the resource assignment is set to a predefined value for the releasing; or
a release flag is included in the configuration.

30.-45. (canceled)

46. A device comprises:
at least one processor; and
at least one memory including computer program code;
the at least one memory and the computer program code configured to, with the at least one processor, cause the device to:
transmit a paging message to a terminal device in an idle or inactive state, the paging message including a configuration related to an uplink positioning reference signal for triggering uplink positioning of the terminal device based on the configuration while the terminal device is in the idle or inactive state, or releasing the uplink positioning while the terminal device is in the idle or inactive state.

47. The device of claim 46, wherein the at least one memory and the computer program code are further configured to, with the at least one processor, cause the device to:
receive, from a location management functionality separate from the device, a paging indication for paging the terminal device to trigger or release the uplink positioning while the terminal device is in the idle or inactive state; and
transmit the paging message to the terminal device in response to the reception of the paging indication.

48. (canceled)

49. The device of claim 46, wherein the configuration comprises at least one of a positioning dedicated channel configuration or an indication of the positioning reference signal to trigger the uplink positioning.

50. The device of claim 49, wherein the indication of the positioning reference signal comprises at least one of a sequence index or a cyclic shift of the positioning reference signal.

51. The device of claim 49, wherein the configuration further comprises at least one of:
a duration of transmissions of the uplink positioning reference signal,
the number of transmissions of the uplink positioning reference signal, or
a period of transmissions of the uplink positioning reference signal.

52.-53. (canceled)

54. The device of claim 49, wherein the positioning dedicated channel configuration comprises a resource for transmitting the uplink positioning reference signal, and wherein the uplink positioning reference signal comprises one of the following for uplink positioning:
a random access preamble,
a sounding reference signal, or
a phase tracking reference signal.

55. (canceled)

56. The device of claim 46, wherein the configuration indicates the releasing of the uplink positioning if one of the following is satisfied:
a resource assignment for the uplink positioning reference signal is absent from the configuration;
the resource assignment is set to a predefined value for indicating the releasing; or
a release flag is included in the configuration.

57. A device comprises:
at least one processor; and
at least one memory including computer program code;
the at least one memory and the computer program code configured to, with the at least one processor, cause the device to:
receive a paging message from a base station, the paging message including a configuration related to an uplink positioning reference signal for triggering uplink positioning based on the configuration or releasing the uplink positioning, while the device is in the idle or inactive state; and
transmit the uplink positioning reference signal based on the configuration or release the uplink positioning in response to the paging message while the device is in the idle or inactive state.

58. (canceled)

59. The device of claim 57, wherein the configuration comprises at least one of a positioning dedicated channel configuration or an indication of the positioning reference signal to trigger the uplink positioning.

60. The device of claim 59, wherein the indication of the positioning reference signal comprises at least one of a sequence index or a cyclic shift of the positioning reference signal.

61. (canceled)

62. The device of claim 59, wherein the configuration further comprises at least one of:
a duration of transmissions of the uplink positioning reference signal,
the number of transmissions of the uplink positioning reference signal, or
a period of transmissions of the uplink positioning reference signal.

63. The device of claim 59, wherein the positioning dedicated channel configuration comprises a resource for transmitting the uplink positioning reference signal, and wherein the uplink positioning reference signal comprises one of the following for uplink positioning:
a random access preamble,
a sounding reference signal, or
a phase tracking reference signal.

64. The device of claim 57, wherein the configuration indicates the releasing of the uplink positioning if one of the following is satisfied:
a resource assignment for the uplink positioning reference signal is absent from the configuration;
the resource assignment is set to a predefined value for indicating the releasing; or
a release flag is included in the configuration.

65.-78. (canceled)
